(19) United States
(12) Patent Application Publication
(10) Pub. No.: US 2002/0174686 A1
(43) Pub. Date: Nov. 28, 2002

(54) Method for producing microchannels having circular cross-sections in glass

(75) Inventors: Peter Krulevitch, Pleasanton, CA (US); Julie K. Hamilton, Tracy, CA (US); Harold D. Ackler, Sunnyvale, CA (US)

Correspondence Address: Alan H. Thompson, Assistant Laboratory Counsel, Lawrence Livermore National Laboratory, P.O. Box 808, L-703, Livermore, CA, 94551, US

(73) Assignee: The Regents of the University of California

(21) Appl. No.: 09/851,231

(22) Filed: May 7, 2001

(51) Int. Cl. C03C 27/00

(52) U.S. Cl. 65/41; 216/2; 216/33; 216/97; 65/104

(57) ABSTRACT

A process for micromachining capillaries was having circular cross-sections in glass substrates. Microchannels are isotropically etched into a flat glass substrate, resulting in a semi-circular half-channel (or a rectangle with rounded corners). A second flat glass substrate is then fusion bonded to the first substrate, producing sealed microchannels with rounded bottom corners and a flat top surface having sharp corners. The process is completed by annealing at a sufficiently high temperature (approximately 750 C.) to allow surface tension forces and diffusional effects to lower the over-all energy of the microchannels by transforming the cross-section to a circular shape. The process can be used to form microchannels with circular cross-sections by etching channels into a glass substrate, then anodically bonding to a silicon wafer and annealing. The process will work with other materials such as polymers.

The United States Government has rights in this invention pursuant to Contract No. W-7405-ENG-48 between the United States Department of Energy and the University of California for the operation of Lawrence Livermore National Laboratory.

### BACKGROUND OF THE INVENTION

The present invention relates to the formation of microchannels, particularly to the formation of microchannels having a circular cross-section, and more particularly to a method for producing circular cross-section microchannels in glass.

Microfabrication has become an enabling technology for development of the generation of analytical instrumentation for performing medical diagnoses, sequencing the human genome, detecting air borne pathogens, and increasing throughput for combinatorial chemistry and drug discovery. These miniature devices take advantage of scaling laws and unique physical phenomena which occur at the micro-scale to perform new types of assays. The large surface area to volume ratio and small size of microfabricated fluidic devices results in laminar flows, increased surface contact between sample fluids and electrodes, fast and uniform heat transfer, and reduced reagent use. Surface tension and viscous forces dominate while inertial effects are negligible.

Microfluidic devices with microelectrodes have the potential to enable studies of phenomena at size scales where behavior may be dominated by different mechanisms than at macroscales. Through work developing microfluidic devices for dielectrophoretic separation and sensing of cells and particles, we have fabricated devices from which general or more specialized research device may be derived. Fluid channels from 80 μm wide×20 μm deep to 1 mm wide×200 μm deep have been fabricated in glass, with lithographically patterned electrodes from 10 to 80 μm wide on one or both sides of the channels and over topographies tens of microns in height. The devices are designed to easily interface to electronic and fluidic interconnect packages that permit reuse of devices, rather than one-time use, crude glue-based methods. Such devices may be useful for many applications of interest to the electrochemical and biological community.

For microfluidics applications in which liquids or gasses pass within microchannels patterned into glass, silicon, or plastic substrates, channel cross-sections having sharp corners cause several problems: (1) fluid carryover trapped in corners can result in cross-contamination; (2) particles such as DNA and beads are easily trapped in corners; (3) corners can be a source of bubble nucleation and/or bubble entrapment; (4) separation efficiencies for applications such as gas chromatography are greatly reduced due to non-uniform diffusion rates out of corner areas. Current microfabrication techniques produce microchannels with rectangular or trapezoidal cross-sections when a planar substrate is bonded onto another substrate which has microchannels etched into it. It is possible to etch mirror-image semi-circular channels into opposing substrates, then bond the two together, but this involves a difficult and critical alignment step. Microchannels with circular cross-sections are highly desirable, but until now have been extremely difficult, if not impossible, to achieve.

Recent efforts have been directed to forming smooth surface microchannels to prevent channel cross-sections having sharp corners to prevent trapping of particles in those sharp corners. These efforts are directed to forming microchannels with circular cross-sections. One approach involves etching a channel into a glass substrate, forming a layer of silicon on the channel surface, forming a layer of wax on the silicon layer, bonding a second plate over the wax, annealing whereby a circular channel is formed, and thereafter removing the wax.

The present invention provides another approach which basically involves etching a channel into a glass substrate, fusion bonding (or glass-glass anodic bonding) a glass substrate over the formed channel, and annealing the glass which transforms the channel cross-section to a circle. The method of the present invention can be utilized with a glass substrate containing etched channel and to which a silicon wafer is anodically bonded, and thereafter annealed. Other materials, such as polymers may be utilized in the present method.

### SUMMARY OF THE INVENTION

It is an object of the present invention to produce microchannels having circular cross sections.

A further object of the invention is to provide a method for producing microchannels in glass having circular cross-sections.

Another object of the invention is to provide a method for micromachining capillaries having circular cross-sections in glass substrates.

Another object of the invention is to provide a method for creating glass microchannels with circular cross-sections by etching a channel into a glass substrate, fusion or anodically bonding a second glass substrate to the first substrate creating a sealed microchannel, and annealing the glass, transforming the channel cross-section to a circle.

Another object of the invention is to produce circular cross-section microchannel in devices which include glass, silicon, or polymer components.

Other objects and advantages of the invention will become apparent from the following description and accompanying drawings. The present invention involves a method for producing microchannels having circular cross-sections, particularly in glass substrates. The method is basically a three (3) step operation composed of etching, bonding, and annealing. Preferably the microchannels are etched into a glass substrate, a glass plate is fusion or anodically bonded to the substrate, and the bonded substrate and plate are then annealed, with circular microchannels being produced thereby. A silicon wafer can be anodically bonded to an etched glass substrate and then annealed to produce microchannels having circular cross-section. Other materials, such as polymers, may be utilized in the process of this invention

### BRIEF DESCRIPTION OF THE DRAWINGS

FIGS. 1-3 illustrate the process of the present invention with FIG. 1 showing an etched substrate, FIG. 2 showing a plate fusion bonded to the substrate, and FIG. 3 showing a circular microchannel formed by annealing the bonded structure of FIG. 2.

### DETAILED DESCRIPTION OF THE INVENTION

The present invention relates to a method for micromachining capillaries having circular cross-sections, particularly in glass substrates. The invention overcomes the above-discussed problems associated with microchannels patterned into glass, silicon, or plastic substrates wherein the channel cross sections have sharp corners. Microchannels with circular cross-sections are highly desirable, but previously have been extremely difficult, if not impossible, to achieve. The method of this invention is simple, cost effective, and produces satisfactory results. The method can be utilized with components composed of glass, silicon, or plastic, and is particularly effective using an etched glass substrate fusion bonded to a glass plate, and then annealed to a sufficiently high temperature of 600° to 800° C., such as 750 C. to allow surface tension forces and diffusional effects to lower the over all energy of the microchannels by transferring the cross-section to a circular shape. If plastic (polymer) components are used the annealing temperature would be lowered to 200° C. and above.

It is also possible, utilizing this invention, to form microchannels with circular cross-sections by etching channels into a glass substrate, then anodically bonding the etched glass substrate to a silicon wafer, followed by annealing, the annealing temperature involving silicon would be in the range of 600° to 800° C. The invention maybe utilized with substrates other than glass, such as silicon and polymers, in which microchannels are formed and top plates are bonded thereto, after which annealing is carried out to produce rounded surfaces, thereby eliminating any sharp corners formed when the top plate is bonded to the substrate containing the microchannels.

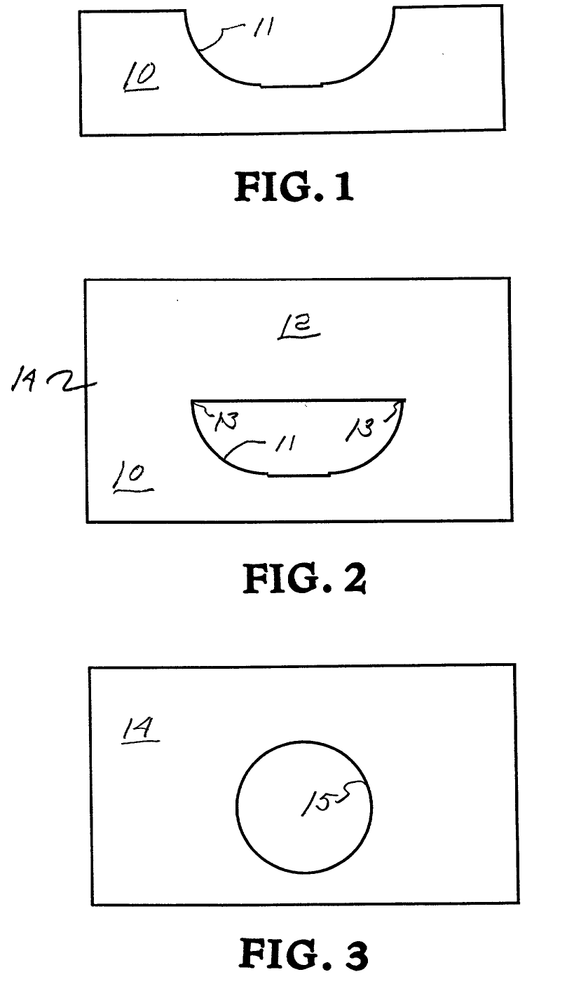

FIGS. 1-3 show the three fabrication steps involved in creating glass microchannels with circular cross-sections, the three steps being described as follows:

In step 1, a glass substrate 10, see FIG. 1, is isotropically etched to form microchannels 11, only one shown. The microchannels can be etched to have various widths, depths, lengths, and configuration including straight, spiral, curved, etc. For example, spiral microchannels may be formed to make a gas or liquid chromatography column.

In step 2, a second glass cover substrate or top plate 12 is fusion (or anodic) bonded, see FIG. 2, to the first substrate 10, sealing the microchannel 11. Note the undesirable sharp corners 13 of FIG. 2. The process may also work if a silicon wafer is anodically bonded to the etched glass substrate 10 and may have certain advantages because anodic bonding is relatively inexpensive and a straight forward process compared to fusion bonding, and, for gas chromatography, the high thermal conductivity of silicon is advantageous. As seen in FIG. 2, the fusion bonding of substrate 10 and plate 12 results in a unified device 14.

The bonding of step 2 of the process may be carried out as follows:

A matched pair of substrates must be precisely aligned, such as using lithographically patterned metal alignment markers, and bonded together. Anodic bond of glass to glass is carried out at a temperature of 550° C. ramping the oven over a 2.5 hour period. High voltage is applied and allowed to ramp to 1000V. The part is annealed for one hour at 550° C. and cooled overnight or about 3 hour ramp down. Fusion bonding of the substrates, wherein the mated surfaces are pressed together at elevated temperatures, has been found to work very reliably. However, the bonding of substrates to form sealed channels is a balance of conflicting needs. High temperatures, pressures, and long bond times improve bond strength and conformal sealing of glass around electrodes, and reduce voids and other defects at the bond interface. However, if the temperature and pressure are too high, or the bond time too long, deformation of the glass may cause the faces of channels parallel to the substrates to be bowed toward each other. The most dramatic case of these results in the opposing faces coming into contact and bonding, closing off the channel. Hence, bonding process variables are determined by the dimensions of the channels. We have determined that temperatures 150-200° below the softening point of the glass, pressures around 5-10 MPa, and times at maximum temperature and pressure of a few hours are suitable for most devices. This method of bonding has also been found to be useful for joining glass and silicon surfaces.

Finally, step 3, as shown in FIG. 3, involves annealing the bonded device or part of FIG. 2 at a sufficiently high temperature such that the glass in fused device 14, composed of substrate 10 and in cover or top plate 12, softens, increasing diffusion rates. When held at temperatures for a long enough time (2 to 24 hrs.), the microchannel cross-section will eventually become circular to lower its overall surface energy. This results in an end produce or glass device 14 having a circular microchannel 15, sealed therein, as shown in FIG. 3. The amount of time required for the process depends on the anneal temperature, and also on the microchannel size. The surface tension forces pulling the cross-section into a circular shape is greater for smaller diameter microchannels. For example with glass substrate 10 having a thickness of 1 mm with microchannel 10 having a depth of 10 μm and width of 20 μm, and glass top plate 12 having a thickness of 1 mm, the annealing temperature would be 600° to 800° C., depending on the composition of the glass in substrate 10 and plate 12, and the annealing time to produce circular microchannels would be 5 to 20 hrs. It should be noted that if only rounded corners instead of the sharp corners 13 in FIG. 2 and an oblong microchannel configuration were desired, the annealing time would be less.

Because the process of the invention is done in glass, a commonly used material for micromachining and a material where there is current micromachining expertise, other silicon and glass components such as injectors and sensors can be integrated along with the microchannels.

The invention has numerous applications in microfluidic systems, such as microfabricated instrument for chemical and biological analysis in gas and liquid state, in particular for chemical and biological warfare agent detection, DNA and protein analysis. Other uses may include columns for hand held gas chromatography, medical diagnostic microsystems incorporating microfluidic chips for genetic analysis and other assays, as well as in instruments for drug discovery and DNA sequencing.

It has thus been shown that the present invention provides a method for producing microchannels in glass having circular cross-sections, and that the method can be used for other materials, such as silicon and polymers.

While a specific example of the method of the invention, along with parameters for carrying of the invention, have been described and/or illustrated to exemplify and teach the principles of the invention, such are not intended to be limiting. Modifications and changes may become apparent to those skilled in the art, and it is intended that the invention be limited only by the scope of the appended claims.

The invention claimed is:

1. In a process for producing microchannels in a device having a substrate with etched microchannels bonded to a top plate, the improvement comprising:
annealing the bonded device to allow surface tension forces and diffusional effects to lower the overall energy of the microchannels by transforming the cross-section to a circular shape.

2. The process of claim 1, additionally included bonding the substrate and top plate by a method selected from the group consisting of fusion bonding and anodic bonding.

3. The process of claim 1, additionally including providing the substrate and/or the top plate from materials selected form the group consisting of glass, silicon and polymer.

4. The process of claim 1, wherein the substrate and top plate are composed of glass, and wherein the bonding in carried out by fusion or anodic bonding.

5. The process of claim 1, wherein the substrate is composed of glass and the top plate is composed of silicon, and wherein the bonding is carried out by anodic bonding.

6. The process of claim 1, wherein the substrate and top plate are composed of glass, and wherein annealing is carried out at a temperature of 600° to 800° C. for a time period of 2 to 24 hrs.

7. A method for producing microchannels having no sharp corners in glass, comprising:
isotropically etching at least one channel into a glass substrate,
bonding a glass plate to the substrate to produce at least one sealed microchannel therein, and
annealing the bonded glass plate and substrate causing transformation of the microchannel cross-section into at least a curved configuration without sharp corners.

8. The method of claim 7, wherein annealing is carried out so as to produce a curved configuration of a substantially circular type.

9. The method of claim 8, wherein the annealing is carried out at a temperature of 600° to 800° C. for a time period of 2 to 24 hrs.

10. The method of claim 7, wherein the bonding is carried out by a process selected from the group consisting of fusion bonding and anodic bonding.

11. In a device having sealed microchannels therein, the improvement comprising:
the sealed microchannels having a curved configuration.

12. The improvement of claim 11, wherein said sealed microchannels have no sharp corners therein.

13. The improvement of claim 11, wherein said curved configuration is circular.

14. The device of claim 11, wherein said sealed microchannels are located with a plurality of bonded members selected from the group consisting of glass members, glass and silicon members, glass and polymer members, and members selected from the group of glass, silicon and polymers.

15. The device of claim 14, wherein said members are composed of glass bonded together by either fusion or anodic bonding, and annealed at a temperature for a time period sufficient to create the curved configuration of the at least one sealed microchannel therein.

16. The device of claim 15, fabricated by annealing the bonded members at a temperature of 200° to 800° C. for a time period of 2 to 24 hrs.
